(19) United States
(12) Patent Application Publication
(10) Pub. No.: US 2011/0315076 A1
(43) Pub. Date: Dec. 29, 2011

(54) PRINTING MEDIUM HOLDER AND PRINTING APPARATUS

(75) Inventor: Osamu Watanabe, Shizuoka (JP)

(73) Assignee: TOSHIBA TEC KABUSHIKI KAISHA, Tokyo (JP)

(21) Appl. No.: 13/169,127

(22) Filed: Jun. 27, 2011

(30) Foreign Application Priority Data
Jun. 29, 2010 (JP) 2010-147561
Jan. 6, 2011 (JP) 2011-001370

(51) Int. Cl. B05C 13/00

(52) U.S. Cl. 118/503; 118/500

(57) ABSTRACT

According to one embodiment, a printing medium holder includes a housing and holding section and a winding-shaft holding section. The housing and holding section is detachably attachable to a member holding section of a printing apparatus. The housing and holding section houses and holds a printing medium wound by rotation of a winding shaft member. The winding-shaft holding section is provided in the housing and holding section. The winding-shaft holding section detachably holds the winding shaft member.

### CROSS-REFERENCE TO RELATED APPLICATIONS

This application is based upon and claims the benefit of priority from Japanese Patent Application No. 2010-147561 filed on Jun. 29, 2010; and Japanese Patent Application No. 2011-1370 filled on Jan. 6, 2011, the entire contents of all of which are incorporated herein by reference.

### FIELD

Embodiments described herein relate generally to a printing medium holder and a printing apparatus.

### BACKGROUND

In the past, there is known a label printer that prints information on a printing surface of a label with mount wound in a roll shape, peels the label, on which the information is printed, off the mount, and issues the label.

In a form of use in which the label printer of this type is used, in order to change a type of a label to be issued by the label printer, in some cases, a label with mount in use is taken out and replaced with a label with mount of another type.

In general, as work for replacing a label with mount in the label printer in the past, first, amount from which a label is peeled and that is wound in a roll shape around a mount winding shaft is cut in an appropriate place by a user. Subsequently, the mount wound around the mount winding shaft is discarded. A label with mount in the roll shape in use held by a holding mechanism is taken out. The taken-out label with mount is stored in a predetermined storage place such as a shelf.

Subsequently, a label with mount of another type, i.e., another new label with mount or another label with mount in use stored in the storage place is held in the holding mechanism by the user. A free end side of the held label with mount is drawn out. The free end side is fixed to the mount winding shaft by fixing means provided in the mount winding shaft.

However, the work for replacing the label with mount in the past is burdensome to the user and replacement efficiency is deteriorated.

### DESCRIPTION OF THE DRAWINGS

FIG. 1 is a perspective view for explaining an external configuration of a label printer according to a first embodiment;

FIG. 2 is a perspective view for explaining an internal configuration of the label printer according to the first embodiment;

FIG. 3 is a perspective view for explaining the configuration of a roll paper holder according to the first embodiment;

FIG. 4 is a perspective view for explaining the configuration of a mount winding shaft according to the first embodiment;

FIG. 5 is a perspective view for explaining a state of detachment of the roll paper holder and the mount winding shaft according to the first embodiment from the label printer;

FIGS. 6A and 6B is a perspective view for explaining a state in which the mount winding shaft is held by the roll paper holder according to the first embodiment and roll paper is stored;

FIG. 7 is a perspective view for explaining the configuration of a roll paper holder according to a modification of the first embodiment;

FIG. 8 is a perspective view for explaining a storage state of the roll paper holder according to the modification of the first embodiment;

FIG. 9 is a perspective view for explaining an internal configuration of a label printer according to a second embodiment;

FIG. 10 is a perspective view for explaining the configuration of a roll paper holder according to the second embodiment, wherein a state in which a grip section is located in a second position is shown;

FIG. 11 is a perspective view for explaining the configuration of the roll paper holder according to the second embodiment, wherein a state in which the grip section is located in a first position is shown;

FIG. 12 is a perspective view for explaining a state in which a mount winding shaft is held by the roll paper holder according to the second embodiment and roll paper is stored;

FIG. 13 is a side view for explaining the state in which the mount winding shaft is held by the roll paper holder according to the second embodiment and the roll paper is stored;

FIG. 14 is a perspective view for explaining a state of detachment of the roller paper holder and the mount winding shaft according to the second embodiment from the label printer;

FIG. 15 is a perspective view of a state of housing of the roll paper holder and the mount winding shaft according to the second embodiment in the label printer; and

FIG. 16 is a perspective view for explaining the configuration of a roll paper holder according to a third embodiment, wherein a state in which a grip section is located in a second position is shown.

### DETAILED DESCRIPTION

In general, according to one embodiment, a printing medium holder includes a housing and holding section and a winding-shaft holding section. The housing and holding section is detachably attachable to a member holding section of a printing apparatus. The housing and holding section houses and holds a printing medium wound by rotation of a winding shaft member. The winding-shaft holding section is provided in the housing and holding section. The winding-shaft holding section detachably holds the winding shaft member.

Embodiments are explained below with reference to the accompanying drawings.

In the following explanation, as a printing apparatus according to the embodiments, a label printer that prints information on a printing surface of a label with mount wound in a roll shape, peels the label, on which the information is printed, off the mount, and issues the label is explained. The printer is set in a backyard or the like of a store that sells commodities. The printer issues a label on which commodity information related to commodities such as commodity names, prices, and barcodes is printed.

In the following explanation, a front side on which a label issue port 3a is provided of a label printer 1 is referred to as “front” and a rear side of the label printer 1 is referred to as “rear”. “Left” and “right” of the label printer 1 are the left and the right of the label printer 1 viewed from the front side.

### First Embodiment

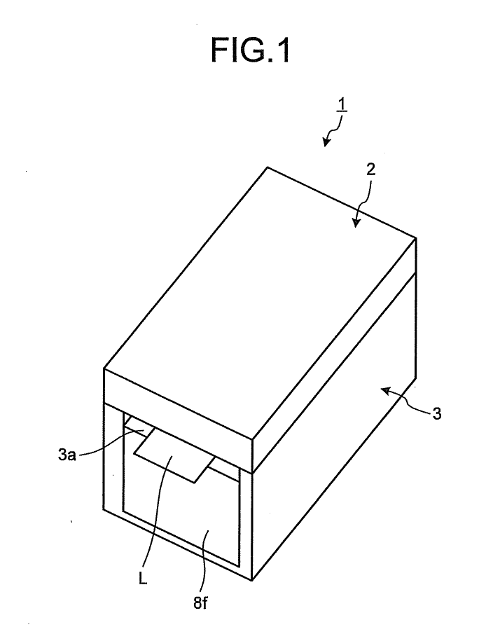

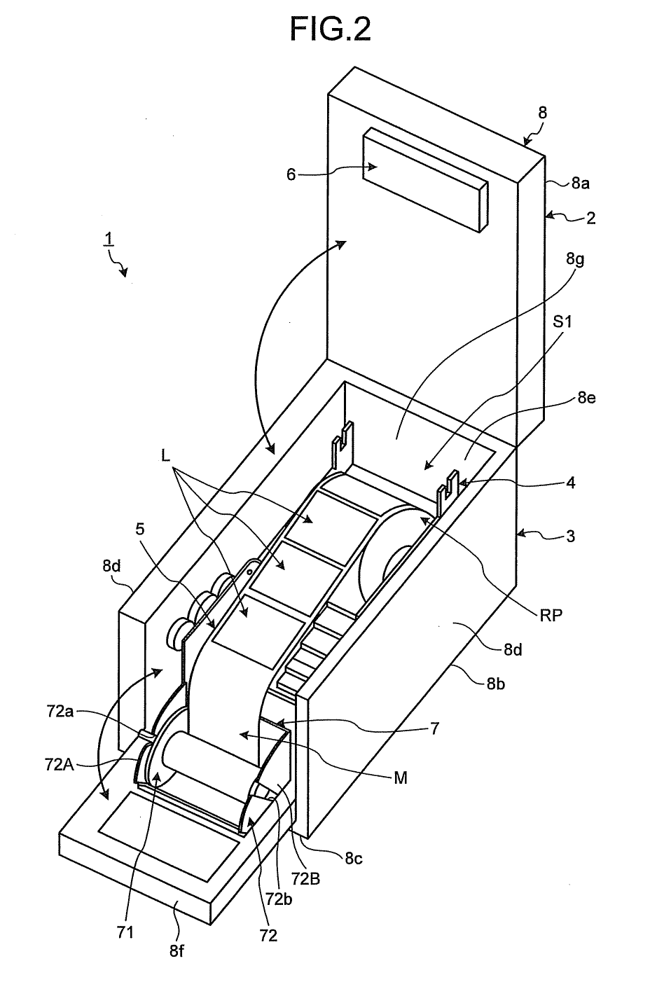

First, a first embodiment is explained. FIG. 1 is a perspective view for explaining an external configuration of the label printer 1 according to this embodiment. FIG. 2 is a perspective view for explaining an internal configuration of the label printer 1.

As shown in FIGS. 1 and 2, the label printer 1 includes an upper unit 2 and a lower unit 3. The rear side of the upper unit 2 is supported on the lower unit 3 by a supporting mechanism (not shown). The upper unit 2 is pivotable to open and close on the upper side of the lower unit 3. A front wall member 8f is provided in the front section of the lower unit 3. A lower part of the front wall member 8f is pivotably supported by a supporting mechanism (not shown). The front wall member 8f is pivotable to open and close on the front side of the lower unit 3.

The label issue port 3a is provided between the upper end of the front wall member 8f and the upper unit 2. The label issue port 3a discharges a label L, on which commodity information is printed, to the outside.

On the inside of the label printer 1, a roll paper holder (a printing medium holder) 4, a conveying mechanism 5, a printing head mechanism (a printing section) 6, a mount winding mechanism 7, and the like are provided. The roll paper holder 4 houses and holds roll paper (a printing medium with mount) RP. The roll paper RP is obtained by winding, in a roll shape, a label obtained by temporarily bonding (sticking) plural labels L to an elongated mount M in a row (in some cases, hereinafter simply referred to as “label with mount”). The conveying mechanism 5 includes a platen roller. The platen roller draws out the label with mount from the roll paper RP held by the roll paper holder 4 and conveys the label with mount in a direction of the label issue port 3a (a conveying direction). The printing head mechanism 6 includes a thermal head. The thermal head nips the label with mount (the printing medium with mount) in conjunction with the platen roller and prints information on a printing surface of the label L. The mount winding mechanism 7 winds the mount M. The mount M to be wound is a portion where the label L printed by the printing head mechanism 6 is peeled. The label printer 1 includes a member holding section 8. The member holding section 8 forms a framework of the label printer 1. The member holding section 8 holds the sections explained above.

Details of the components 4 to 8 are explained below.

The member holding section 8 includes a cover section 8a and a base section 8b. The cover section 8a is provided in the upper unit 2. The base section 8b is provided in the lower unit 3. The cover section 8a is pivotably coupled to the rear end of the base section 8b to be capable of opening and closing an upper surface opening of the base section 8b. The base section 8b is formed in a box shape of the upper surface opening. Specifically, the base section 8b includes a bottom wall section 8c, sidewall sections 8d, a rear wall section 8e, and the front wall member (a front panel) 8f. The bottom wall section 8c is formed in a rectangular plate shape. A pair of left and right sidewall sections 8d are vertically provided at both the side edges of the bottom wall section 8c. The rear wall section 8e is vertically provided at the rear edge of the bottom wall section 8c. The front wall member 8f is pivotably coupled to the pair of sidewall sections 8d. The front wall member 8f is pivotably coupled to the lower ends of the pair of sidewall sections 8d via a supporting mechanism such as a shaft.

The member holding section 8 includes a holder holding section 8g and a winding-shaft holding section 72. The holder holding section 8g detachably holds the roll paper holder 4. The holder holding section 8g is formed by the bottom wall section 8c, the pair of left and right sidewall sections 8d, the rear wall section 8e, and the like in a rear part of the base section 8b. The upper surface of the holder holding section 8g is opened. The inside of the holder holding section 8g is a housing space S1 that houses the roll paper holder 4. The winding-shaft holding section 72 detachably holds a mount winding shaft (a winding shaft member) 71 explained later.

The roll paper holder 4 is an instrument detachably attached to the holder holding section 8g of the member holding section 8. If the roll paper holder 4 is housed in the housing space S1 of the lower unit 3 and attached to the member holding section 8 of the label printer 1, the roll paper holder 4 functions as a holding mechanism. The holding mechanism is a mechanism for housing and holding the roll paper RP. If the roll paper holder 4 is taken out from the housing space S1 of the lower unit 3 in a state in which the upper unit 2 is opened, the roll paper holder 4 functions as a storing member in a storage place such as a shelf in a store. The storing member is a member for stably storing the roll paper RP in use without allowing the roll paper RP to rotate because of, for example, a tilt of a placing surface.

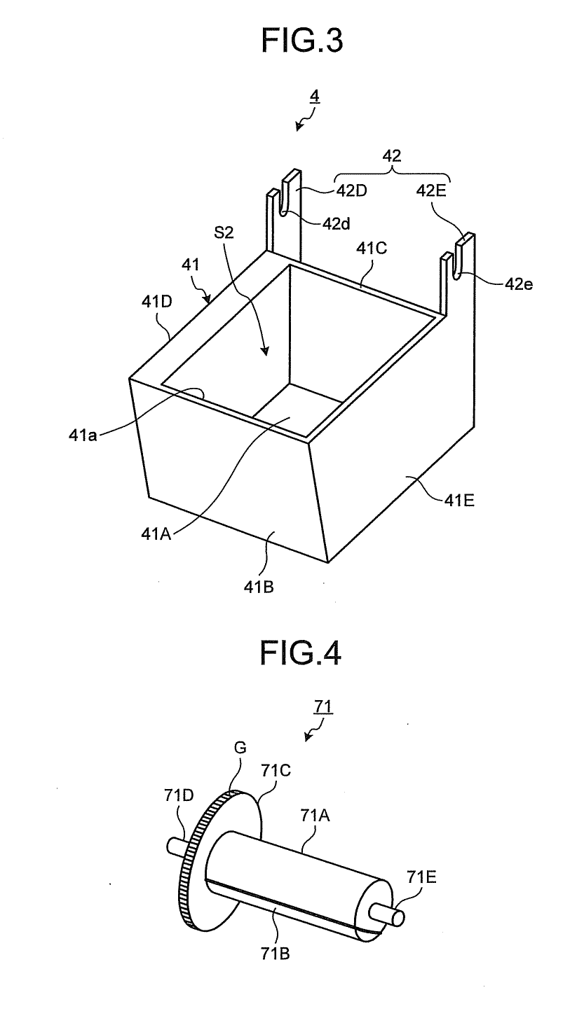

FIG. 3 is a perspective view for explaining the configuration of the roll paper holder 4.

As shown in FIG. 3, the roll paper holder 4 mainly includes a housing and holding section 41 and a winding-shaft holding section 42. The housing and holding section 41 houses and holds the roll paper RP loaded by a user. The winding-shaft holding section 42 detachably holds the mount winding shaft (the winding shaft member) 71 of the mount winding mechanism 7.

More specifically, the housing and holding section 41 includes a bottom member 41A and wall members 41B to 41E in the front and rear and on the left and right of the housing and holding member 41. The front, rear, left, and right wall members 41B to 41E are vertically provided on the bottom member 41A. A roll paper loading opening 41a, which opens upward, is formed in the housing and holding section 41. A housing space S2 is formed in the housing and holding section 41. The housing space S2 houses the roll paper RP loaded from the roll paper loading opening 41a.

The roll paper loading opening 41a and the housing space S2 are formed in size for allowing loading of one roll paper RP by the user, i.e., size for allowing the roll paper RP to be loaded with a rotation axis thereof set sideways (in the left-right direction).

The roll paper loading opening 41a and the housing space S2 are formed in size corresponding to plural kinds of the roll paper RP usable in the label printer 1.

The winding-shaft holding section 42 detachably holds the winding shaft member 72 detached from the member holding section 8. The winding-shaft holding section 42 includes two supporting plate members 42D and 42E opposed to each other. The supporting plate members 42D and 42E are extended to the rear side respectively from the rear ends of the left and right wall members 41D and 41E. The upper ends of extended portions in the supporting plate members 42D and 42E are extended further upward than the upper ends of the left and right wall members 41D and 41E. At the upper ends of the supporting plate members 42D and 42E, a pair of winding-shaft holding grooves 42d and 42e are formed. The inner surfaces of the winding-shaft holding grooves 42d and 42e are formed in a U shape.

In this embodiment, the dimension of groove width of the winding-shaft holding grooves 42d and 42e is designed such that pivot shafts 71D and 71E (see FIG. 4) of the mount winding shaft 71 inserted in the winding-shaft holding grooves 42d and 42e are firmly fit therein.

Besides the dimension design for the groove width, it is also possible to additionally provide a lock mechanism for locking the pivot shafts 71D and 71E (see FIG. 4) of the mount winding shaft 71 inserted in the winding-shaft holding grooves 42d and 42e.

In the explanation of this embodiment, the shapes of the winding-shaft holding grooves 42d and 42e are the U shape. However, the shapes of the winding-shaft holding grooves 42d and 42e can be other shapes.

The height dimensions of the wall members 41B to 41E and the supporting plate members 42D and 42E are designed as appropriate on the basis of the sizes of the roll paper RP and the mount winding shaft 71 to be housed and according to a purpose of stably housing the roll paper RP and stably holding the mount winding shaft 71.

Referring back to FIG. 2, the conveying mechanism 5 includes the platen roller and a motor (not shown). The conveying mechanism 5 drives to rotate the platen roller with the motor to thereby convey a label with mount. The printing head mechanism (the printing section) 6 includes the thermal head and a thermal-head driving section (not shown). The thermal head includes a heat generating member (not shown). The printing head mechanism 6 drives the thermal head with the thermal-head driving section to thereby print information on a printing surface of the label with mount. The printing head mechanism 6 is printing means. The printing head mechanism 6 is fixed to the cover section 8a of the member holding section 8.

The mount winding mechanism 7 includes the mount winding shaft 71 and the winding-shaft holding section 72. The winding-shaft holding section 72 holds the mount winding shaft 71. The mount winding mechanism 7 winds the mount M from which the label L is peeled. The mount winding mechanism 7 is mount winding means.

The winding-shaft holding section 72 is attached close to the lower end of the inner surface of the front wall member 8f. The winding-shaft holding section 72 includes, on the left and right, two arcuate sidewalls 72A and 72B opposed to each other. A pair of U-shaped winding-shaft holding grooves 72a and 72b are formed on the circumference side of the two sidewalls 72A and 72B.

The winding-shaft holding section 72 is pivoted together with the front wall member 8f. The front wall member 8f is closed in a state in which the mount winding shaft 71 is held by the winding-shaft holding section 72. Specifically, in a state shown in FIG. 1, a driven gear G (see FIG. 4) of the mount winding shaft 71 held by the winding-shaft holding section 72 is engaged with a winding driving mechanism (not shown) including a driving gear and a motor provided in the housing space 51.

FIG. 4 is a perspective view for explaining the configuration of the mount winding shaft 71.

As shown in FIG. 4, the mount winding shaft 71 includes a base 71A, a fixing section 71B, and a flange 71C. The base 71A is given rotation force and rotates to thereby wind the mount M. The fixing section 71B fixes the free end side of the roll paper RP released from a roll state of the roll paper RP housed and held in the housing and holding section 41. Specifically, the fixing section 71B fixes the free end side of the mount M wound around the base 71A. The fixing section 71B is detachably attachable to the base 71A. The fixing section 71B nips the mount M between the fixing section 71B and the base 71A to fix the free end side of the mount M. The fixing section 71B and the base 71A form a cylindrical member. The flange 71C is attached to a surface on one side of the base 71A. The flange 71C guides one side of the mount M wound around the base 71A. The flange 71C is formed in a disc shape.

The pair of pivot shafts 71D and 71E having the same diameter are provided on both the side surfaces of the base 71A. The pivot shafts 71D and 71E are pivotably held by the winding-shaft holding section 72. The driven gear G is formed on the circumferential surface of the flange 71C. The driven gear G is engaged in the driving gear of the winding driving mechanism.

On the inside of the label printer 1 shown in FIGS. 1 and 2, besides the components explained above, a microcomputer, other various circuits (not shown), a power supply device (not shown), and the like are provided. The microcomputer includes a CPU (Central Processing Unit) (not shown), a ROM (Read Only Memory) (not shown), and a RAM (Random Access Memory) (not shown). The microcomputer performs driving control for the conveying mechanism 5, the printing head mechanism 6, the winding driving mechanism, and the like. The microcomputer executes processing related to heat generation control for the heat generating member of the printing head mechanism 6. The power supply device supplies electric power, which is supplied from an external power supply (not shown) such as a commercial power supply, to load sections such as a driving system.

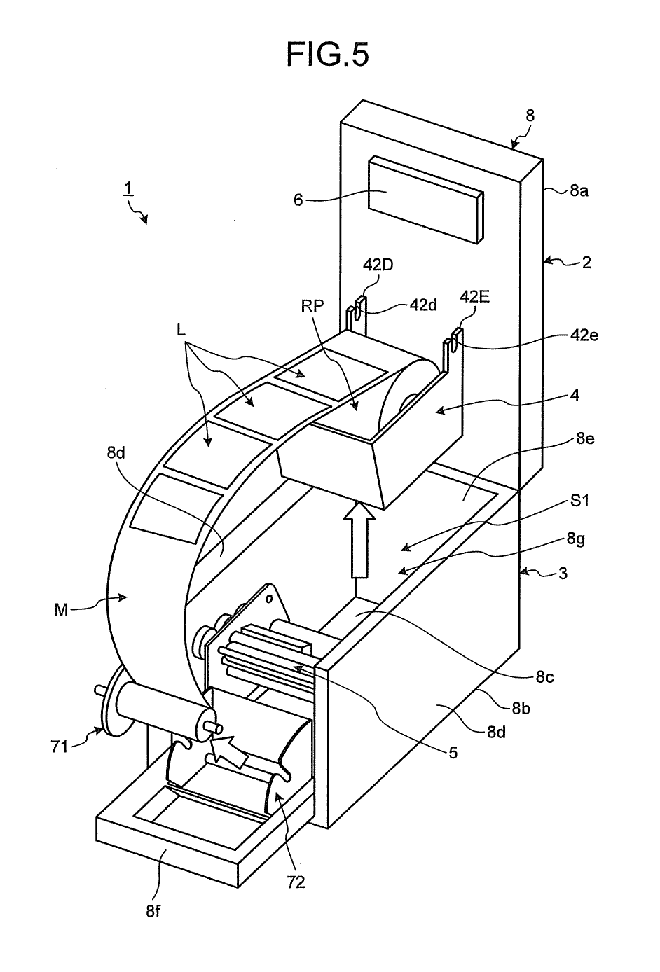

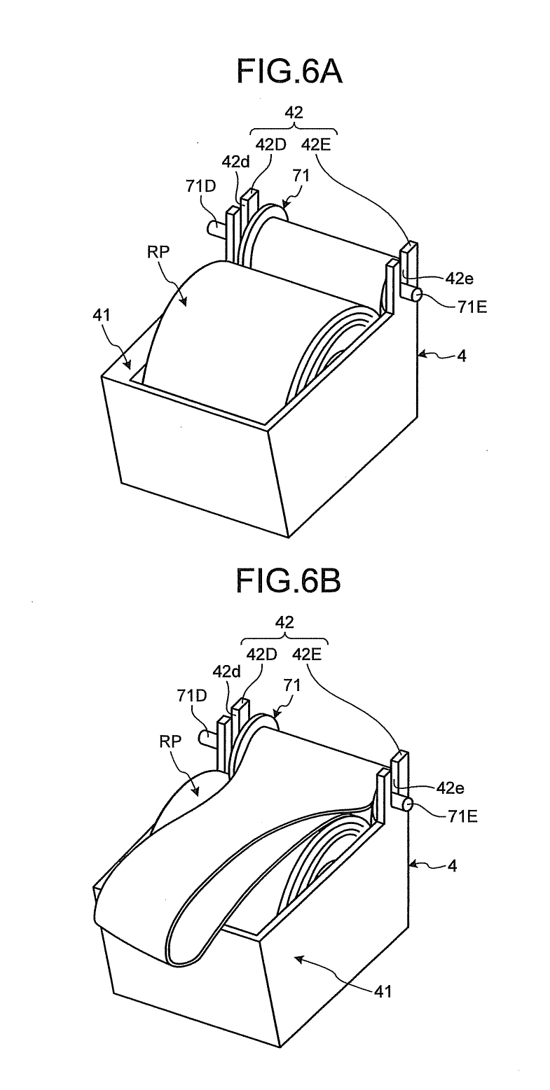

The roll paper RP in use used by the label printer 1 having the configuration explained above is stored and the stored roll paper RP in use is reused as explained below with reference to FIGS. 5, 6A, and 6B.

FIG. 5 is a perspective view for explaining a state of detachment of the roll paper holder 4 and the mount winding shaft 71 from the label printer 1. FIGS. 6A and 6B is a perspective view for explaining a state in which the mount winding shaft 71 is held by the roll paper holder 4 and the roll paper RP is stored.

As shown in FIG. 5, in the label printer 1 according to this embodiment, a layout configuration is adopted in which, in a state in which the upper unit 2 and the front wall member 8f are opened, the roll paper holder 4 and the mount winding shaft 71 and the entire roll paper RP wound, suspended, and held by the roll paper holder 4 and the mount winding shaft 71 (in some cases, hereinafter simply referred to as “detachable members”) can be taken out in the same direction. The same direction is the upward direction in FIG. 5.

Therefore, if the roll paper RP in use is stored because, for example, a type of a label is changed, the user can take out the detachable members in the upward direction without cutting the mount M with scissors or the like unlike in the past.

Specifically, the user holds the two supporting plate members 42D and 42E and takes out the roll paper holder 4. Subsequently, the user places the taken-out roll paper holder 4 on a table or the like on which the label printer 1 is set. The user holds the base 71A or the like of the base winding shaft 71 and detaches the mount winding shaft 71 from the winding-shaft holding section 72. The user fits the pivot shafts 71D and 71E of the detached mount winding shaft 71 in the winding-shaft holding grooves 42d and 42e of the placed roll paper holder 4 and holds the mount winding shaft 71 in the winding-shaft holding section 42 (see FIGS. 6A and 6B). Subsequently, the user stores the roll paper holder 4 in that state in a predetermined storage place such as a shelf in the store.

A storage state shown in FIG. 6A indicates a storage state in which a portion released from the roll state of the roll paper RP is wound around the mount winding shaft 71, which is detached from the winding-shaft holding section 72, to be returned to the roll state and the mount winding shaft 71 is held by the winding-shaft holding section 42.

On the other hand, a storage state shown in FIG. 6B indicates a storage state in which the mount winding shaft 71 with the portion released from the roll state of the roll paper RP left as released is held by the winding-shaft holding section 42.

If the roll paper RP in use stored as explained above is reused, the roll paper RP in use can be set in the label printer 1 by performing a procedure opposite to the procedure of the storage explained above.

Specifically, for example, the user carries, from the storage place, the roll paper holder 4 stored in the state shown in FIG. 6B and places the roll paper holder 4 on the table. Subsequently, the user holds, for example, the base 71A of the mount winding shaft 71 of the placed roll paper holder 4 and detaches the mount winding shaft 71 from the winding-shaft holding section 42. The user holds the mount winding shaft 71 in the winding-shaft holding section 72 provided in the label printer 1.

Subsequently, the user holds the two supporting plate members 42D and 42E of the roll paper holder 4 and houses the roll paper holder 4 in the storage space S1 of the lower unit 3.

In the past, if a label with mount in use stored in a storage place is reused, burdensome work for fixing a free end side of the label with mount in use to a mount winding shaft using fixing means is necessary. However, in the label printer 1 according to this embodiment, since such burdensome work is unnecessary, it is possible to improve efficiency of replacement work for the label with mount.

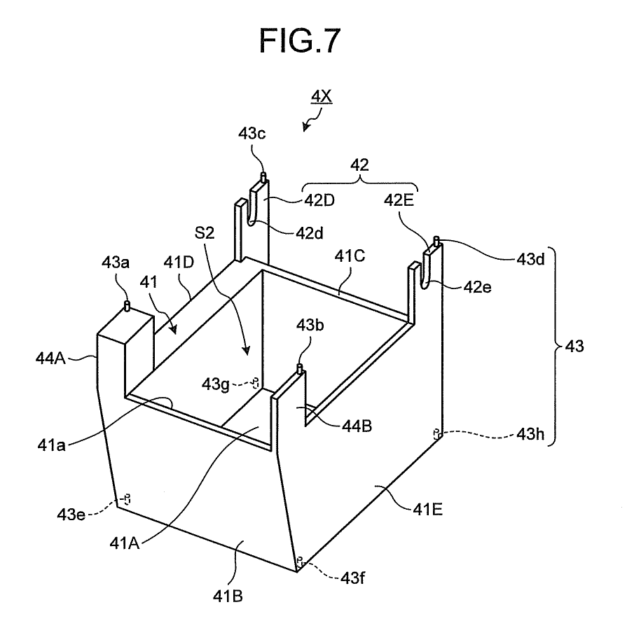

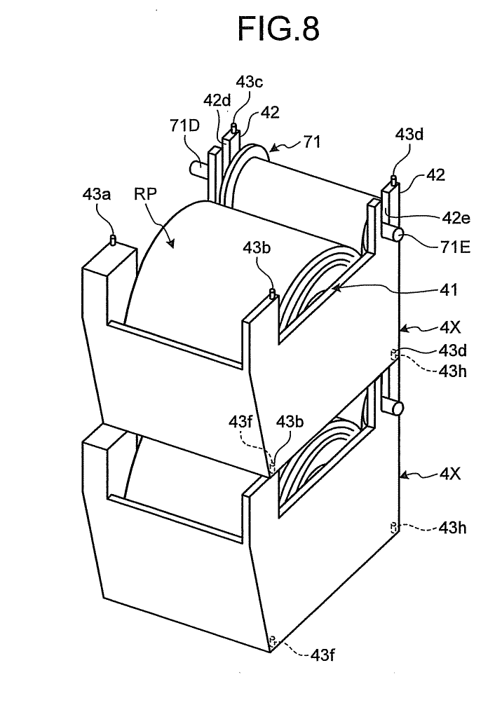

A modification of the roll paper holder 4 is explained with reference to FIGS. 7 and 8.

FIG. 7 is a perspective view for explaining the configuration of a roll paper holder (a printing medium holder) 4X according to the modification. In the following explanation, components same as the components of the roll paper holder 4 shown in FIG. 3 are denoted by the same reference numerals and signs and explanation of the components is omitted.

As shown in FIG. 7, in the roll paper holder 4X, as a component different from that of the roll paper holder 4 shown in FIG. 3, a coupling section (an engaging section) 43 for coupling the roll paper holder 4X to another roll paper holder 4X is provided.

Specifically, the coupling section 43 includes projected portions 43a to 43d and recessed portions 43e to 43h. The projected portions 43a to 43d fit in the recessed portions 43e to 43h provided in the other roll paper holder 4X. The recessed portions 43e to 43h fit in the projected portions 43a to 43d provided in the other roll paper holder 4X.

In this example, the projected portion 43c is provided close to the rear at the upper end of the supporting plate member 42D. The projected portion 43d is provided close to the rear at the upper end of the supporting plate member 42E.

The projected portion 43a is provided close to the front at the upper end of the wall member 41D and close to the rear at the upper end of a supporting plate member 44A vertically provided upward from the upper end of the wall member 41D. The projected portion 43b is provided close to the front at the upper end of the wall member 41E and close to the rear at the upper end of a supporting plate member 44B vertically provided upward from the upper end of the wall member 41E.

In this embodiment, the front side of the roll paper holder 4X, i.e., a portion between the two supporting plate members 44A and 44B is opened not to obstruct conveyance of a label with mount of the roll paper RP housed in the housing and holding section 41 of the roll paper holder 4X in a state in which the roll paper holder 4X is set in the label printer 1. However, a form of the front side of the roll paper holder 4X is not limited to this. The portion between the two supporting plate members 44A and 44B can be closed.

With the roll paper holder 4X having the configuration shown in FIG. 7, the roll paper holders 4X can be placed one on top of another in the up-down direction in the storage place. Therefore, it is possible to effectively use the space of the storage place.

According to this embodiment explained above, it is possible to store the roll paper RP in use together with the mount M wound around the mount winding shaft 71. Therefore, during the next reuse, work for fixing the free end side of the roll paper RP in use with the fixing section is unnecessary. The roll paper RP in use can be easily set. Therefore, it is possible to simplify roll paper replacement work by the user.

According to this embodiment, in particular, it is possible to improve usability of a label printer in a form of use for frequently changing a type of the roll paper RP (i.e., a type of labels).

According to this embodiment, since the roll paper holders 4 and 4X can be stored one on top of another, it is possible to effectively use the setting space of the storage place.

The description is made on the basis of the exemplary embodiment. However, the present disclosure is not limited by the embodiment.

In the embodiment, the roll paper holders 4 and 4X of a loading type (an throw-in type) are explained. However, a roll paper holder is not limited to this. For example, the roll paper holder can be a roll paper holder including a holding shaft that supports the shaft of the roll paper RP.

In the embodiment, the roll paper holders 4 and 4X that the user can take out from the housing space S1 of the lower unit 3 by holding the two supporting plate members 42D and 42E are explained. However, the roll paper holders 4 and 4X are not limited to this. For example, the roll paper holders 4 and 4X can be the roll paper holders 4 and 4X in which exclusive grip sections, which the user can grip, are provided in the wall members 41B and 41C in the front and the rear of the roll paper holders 4 and 4X.

In the embodiment, as the engaging section to be engaged with the other roll paper holder 4X, the coupling section 43 including the projected portions 43a to 43d and the recessed portions 43e to 43h is shown. However, the engaging section is not limited to this. For example, an engaging section for joining the other roll paper holder 4X can be simply provided. Specifically, for example, plane sections for placing the other roll paper holder 4X are respectively provided at the upper ends of the four supporting plate members 42D, 42E, 44A, and 44B.

The engaging section may be provided in the left-right direction besides the up-down direction of the roll paper holder 4X.

In the explanation in the embodiment, the roll paper RP obtained by winding, in a roll shape, the label with mount obtained by temporarily bonding the plural labels L to the elongated mount M in a row is used as roll paper. However, the roll paper is not limited to this. For example, roll paper obtained by winding, in a roll shape, a label with mount obtained by temporarily bonding an elongated label L on the elongated mount M can also be used. In such a case, a cut mechanism for cutting, at predetermined length, the label L peeled off the mount M is provided in the label printer 1.

In the embodiment, taking into account securing of a setting space for the printing head mechanism 6 and a reduction in the sizes of the upper unit 2 and the lower unit 3, as a desirable form, the form in which the supporting plate members 42D and 42E are provided on the rear side of the roll paper holders 4 and 4X is explained. However, the desirable form is not limited to this. For example, the supporting plate members 42D and 42E can be provided on the front side, substantially near the center, or the like of the roll paper holders 4 and 4X as well.

Besides, the shape and the configuration of the label printer 1, the shapes and the configurations of the roll paper holders 4 and 4X and the mount winding shaft 71, and the like are described as mere examples. The present disclosure is not limited by the shapes and the configurations.

### Second Embodiment

A second embodiment is explained below. Components same as the components in the embodiment explained above are denoted by the common reference numerals and signs and redundant explanation of the components is omitted.

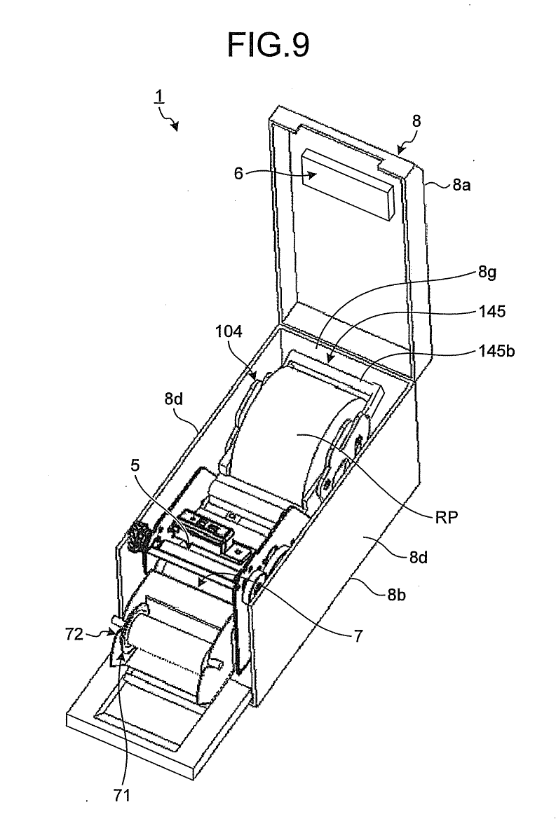

In this embodiment, as shown in FIG. 9, a roll paper holder 104 is different from the roll paper holder 4 according to the first embodiment.

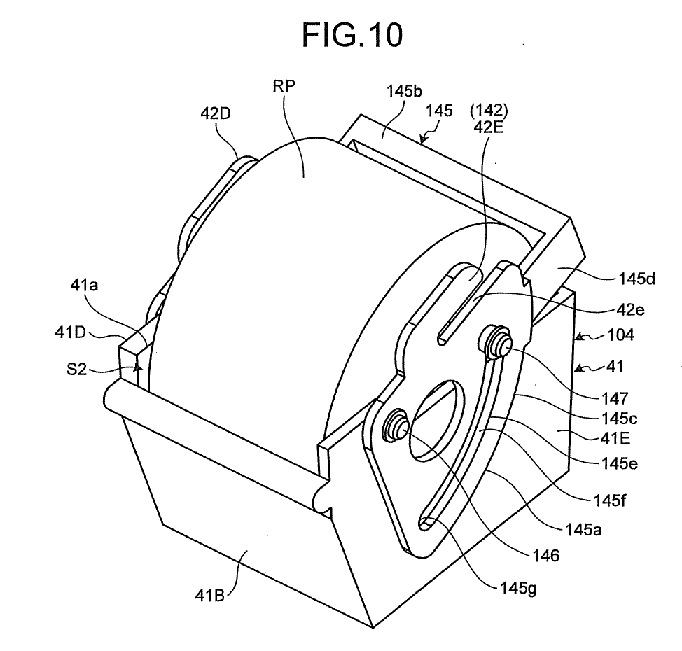

As shown in FIGS. 10 to 13, the roll paper holder 104 includes a grip section 145 joined to the housing and holding section 41. The grip section 145 is pivotably coupled to the housing and housing section 41. The grip section 145 is capable of suspending and supporting the housing and holding section 41 by being lifted.

The grip section 145 includes a pair of left and right side plate sections 145a and the grip body section 145b. The grip body section 145b is laid between the pair of side plate sections 145a. The grip body section 145b is formed in a plate shape elongated in the left-right direction.

The pair of side plate sections 145a are arranged in positions where a pair of side plate members 41E of the housing and holding section 41 are held between the pair of side plate sections 145a. Each of the side plate sections 145a includes a base 145c and a connecting section 145d. The base 145c is formed in substantially a fan shape in side view. The connecting section 145d extends from an arcuate outer circumference of the base 145c. An end of the grip body section 145b is connected to an extending distal end of the connecting section 145d.

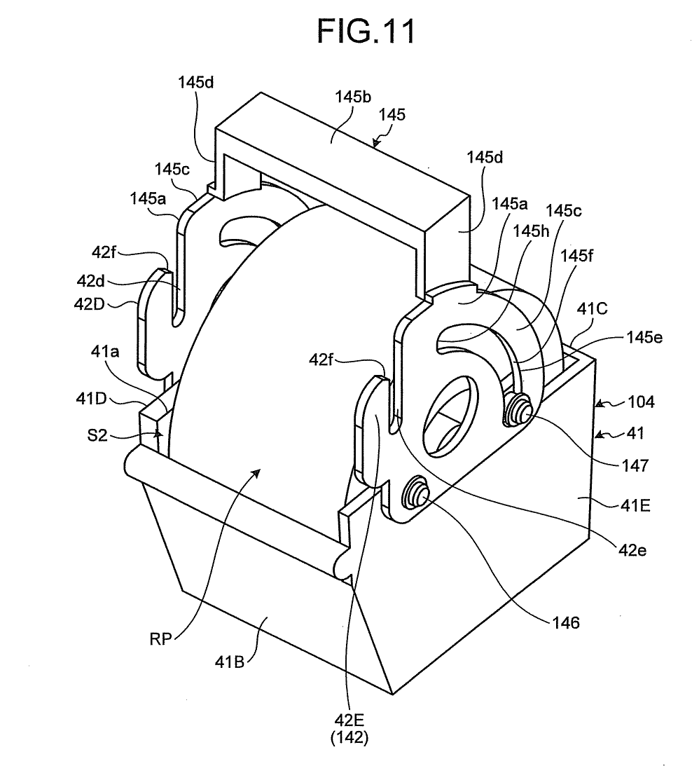

In the base 145c of each of the side plate sections 145a, a portion near the center of the fan shape is pivotably attached to the side plate member 41E of the housing and holding section 41 by a screw member 146 functioning as a supporting shaft. Consequently, the grip section 145 is pivotably coupled to the housing and holding section 41. Specifically, the grip section 145 is capable of pivoting between a first position (FIG. 11) and a second position (FIG. 10). The first position is a position where the grip body section 145b is located above the housing and holding section 41 and the grip section 145 can suspend and support the housing and holding section 41. The second position is a position where the housing and holding section 41 is located lower compared with a position where the housing and holding section 41 is located when the grip section 145 is located in the first position.

The roll paper holder 104 includes a screw member 147 functioning as a pivoting regulating section. The screw member 147 regulates the pivoting of the grip section 145 by coming into contact with the grip section 145 that is located in the first position and suspends and supports the housing and holding section 41. Specifically, the screw member 147 is engaged with an engaging section 145e provided in the side plate section 145a. An arcuate long hole 145f is formed in the engaging section 145e. The long hole 145f is formed in an arcuate shape centering around the screw member 146 that is a pivotal center of the grip section 145. The screw member 147 is screwed in the side plate member 41E of the housing and holding section 41 in a state in which the screw member 147 is inserted through the long hole 145f. If the grip section 145 is located in a position between the first position and the second position, the screw member 147 is not in contact with the circumferential surface of the long hole 145f in the engaging section 145e and allows the pivoting of the grip section 145. On the other hand, in a state in which the grip section 145 is located in the first position, the screw member 147 is in contact with one end 145g of the circumferential surface of the long hole 145f and regulates moving of the grip section 145 from the first position to the opposite side of the second position side. In a state in which the grip section 145 is located in the second position, the screw member 147 is in contact with the other end 145h of the circumferential surface of the long hole 145f and regulates moving of the grip section 145 from the second position to the opposite side of the first position side.

The screw member 146 functioning as a pivotal fulcrum of the grip section 145 is located further in the front than the center of gravity of the housing and holding section 41. Consequently, when a user lifts the grip section 145, the screw member 147 always comes into contact with one end 145g of the circumferential surface of the long hole 145f. Therefore, the user can stably lift the roll paper holder 104 using the grip section 145.

In this embodiment, a winding-shaft holding section 142 is provided in the grip section 145. The wall members 41D and 41E on the left and right of the winding-shaft holding section 142 are respectively provided integrally with the pair of left and right side plate sections 145a of the roll paper holder 104. In a state in which the grip section 145 is located in the first position, the winding-shaft holding section 142 is located in the front of the center of the roll paper RP in the front-rear direction of the roll paper holder 104. As in the first embodiment, the winding-shaft holding grooves 42d and 42e, the inner surfaces of which are formed in a U shape, are formed in the wall members 41D and 41E of the winding-shaft holding section 142. The winding-shaft holding grooves 42d and 42e are formed in a vertically long linear shape from openings 42f to the bottoms thereof.

In a state in which the grip section 145 is located in the first position, the winding-shaft holding grooves 42d and 42e are located in the front of the screw member 146 in the front-rear direction of the roll paper holder 104. In this embodiment, in a state in which the winding shaft member 71 is held in the winding-shaft holding section 142, the mount M wound by the winding shaft member 71 can come into contact with the outer circumferential surface of a roll portion RP1 of the roll paper RP housed and held in the housing and holding section 41. In other words, in a state in which the winding shaft member 71 is held by the winding-shaft holding section 142, the outer circumference of the roll paper RP wound by the winding shaft member 71 can come into contact with the outer circumference of the roll paper RP housed and held in the housing and holding section 41.

The roll paper RP in use used by the label printer 1 having the configuration explained above is stored and the stored roll paper RP in use is reused as explained below with reference to FIGS. 9, 14, and 15.

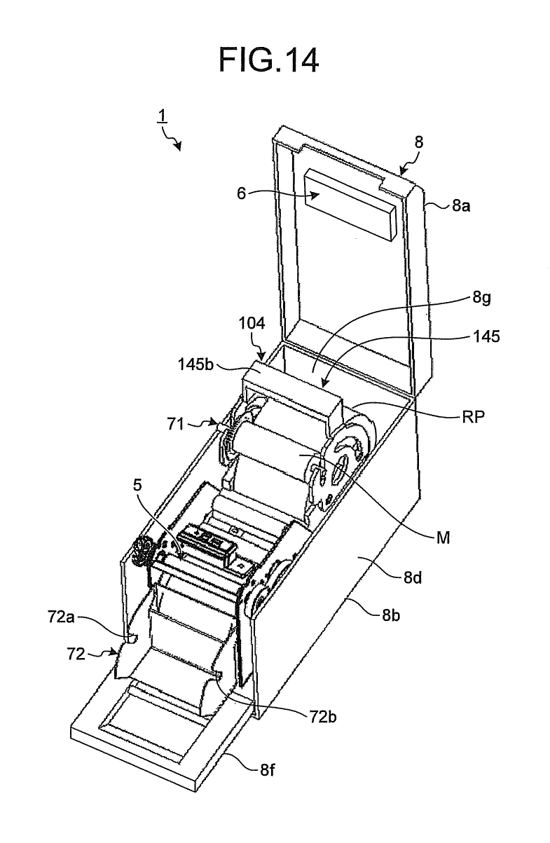

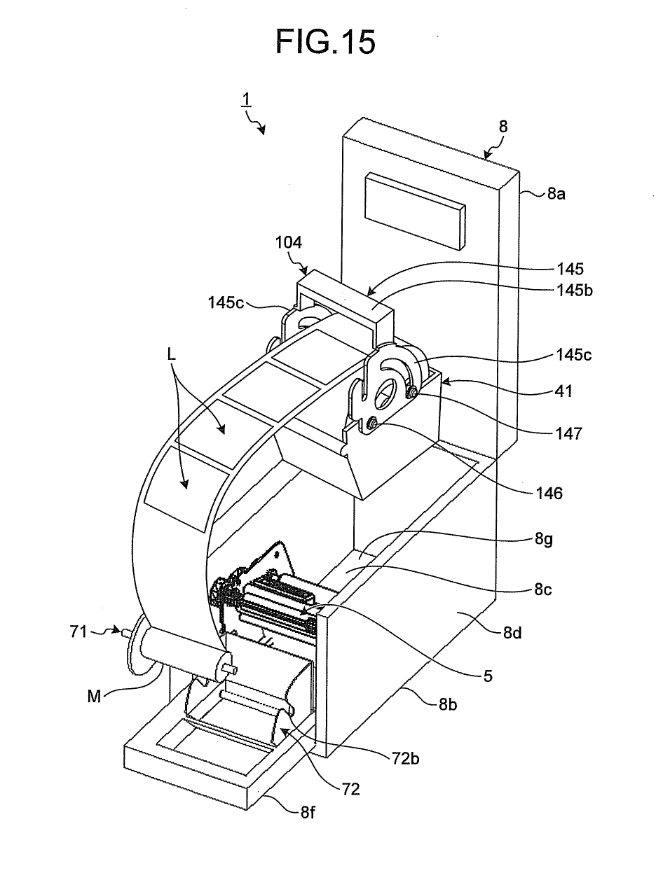

FIG. 14 is a perspective view for explaining a state of detachment of the roll paper holder 104 and the mount winding shaft 71 according to this embodiment from the label printer 1. FIG. 15 is a perspective view for explaining a state of housing of the roll paper holder 104 and the mount winding shaft 71 according to this embodiment in the label printer 1.

In this embodiment, as shown in FIG. 9, the roll paper holder 104 is housed and held in the holder holding section 8g in a state in which the grip section 145 is located in the second position. The mount M of the roll paper RP is fixed to the mount winding shaft 71 from the roll paper holder 104 in such a state, whereby the label printer 1 can be used.

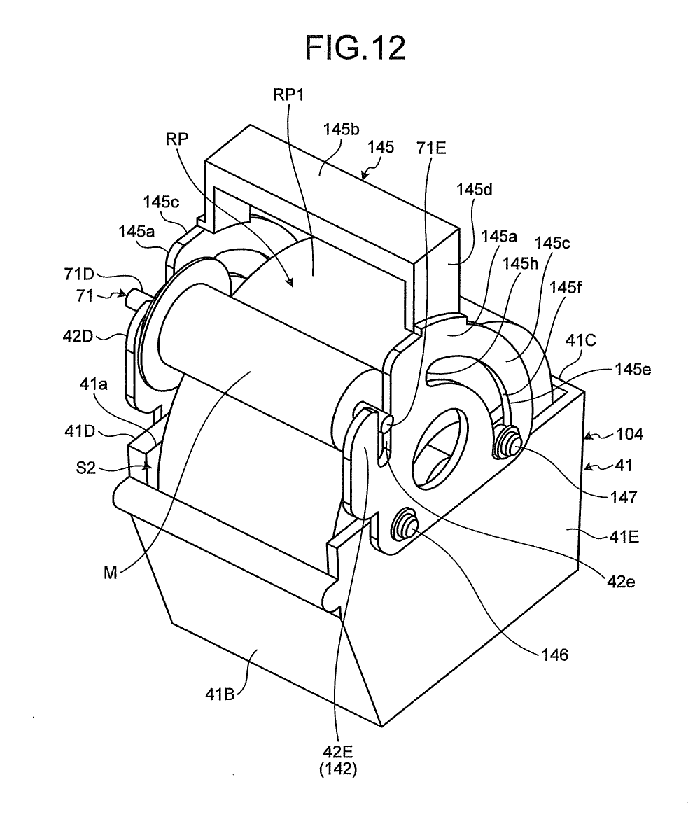

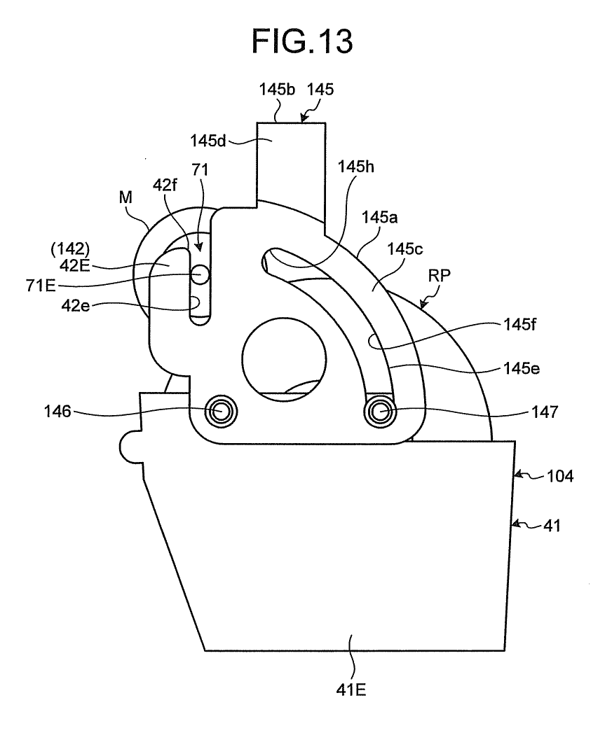

If the roll paper holder 104 is detached from the holder holding section 8g, as shown in FIG. 15, the user moves the grip section 145 of the roll paper holder 104 to the first position. The user grips the grip section 145 located in the first position, lifts the roll paper holder 104, and detaches the roll paper holder 104 from the holder holding section 8g. In this case, the user detaches the mount winding shaft 71 from the winding-shaft holding section 72. The user attaches the winding-shaft holding section 72 to the winding-shaft holding section 142 of the roll paper holder 104 (FIGS. 12 and 13). In this state, the user stores the roll paper holder 104.

On the other hand, when the user attaches the roll paper holder 104 to the member holding section 8, as shown in FIG. 15, the user houses the roll paper holder 104 in the holder holding section 8g. The user attaches the mount winding shaft 71, which is detached from the winding-shaft holding section 142, to the winding-shaft holding section 72. Consequently, the roll paper RP in use can be reused.

As explained above, in this embodiment, as shown in FIGS. 10 to 13, the roll paper holder 104 includes the grip section 145 joined to the housing and holding section 41. Therefore, when the user attaches and detaches the roll paper holder 104 to and from the holder holding section 8g, the user can grip the grip section 145 and move the roll paper holder 104. Consequently, according to this embodiment, the user can easily attach and detach the roll paper holder 104 to and from the holder holding section 8g.

### Third Embodiment

A third embodiment is explained below. Components same as the components in the embodiments explained above are denoted by the common reference numerals and signs and redundant explanation of the components is omitted.

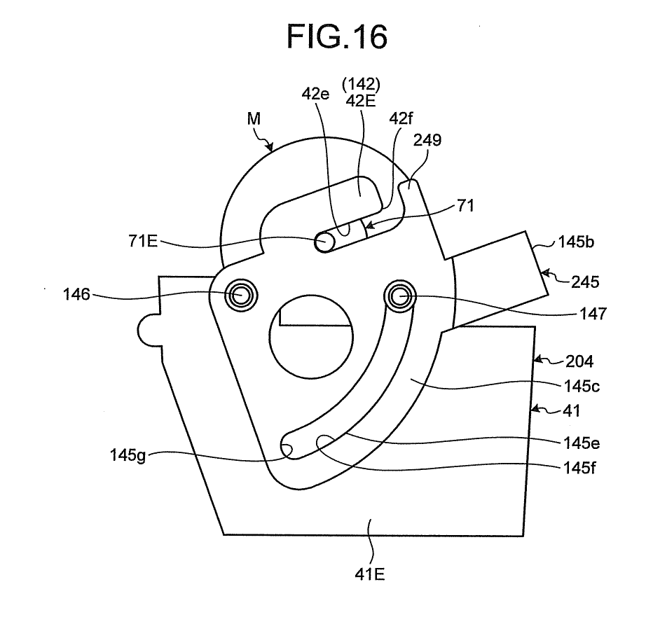

As shown in FIG. 16, this embodiment is different from the second embodiment in that a grip section 245 of a roll paper holder 204 includes shaft regulating sections 249.

The shaft regulating sections 249 are respectively provided in the pair of side plate sections 145a. The shaft regulating sections 249 are formed in a projected shape to be spaced apart from the openings 42f of the holding grooves 42d and 42e and cover the openings 42f. The shaft regulating sections 249 change an exit direction of the openings 42f. The shaft regulating sections 249 regulate disengagement of the pivot shafts 71D and 71E from the holding grooves 42d and 42e by coming into contact with the pivot shafts 71D and 71E. The shaft regulating sections 249 regulate linear movement of the pivot shafts 71D and 71E from the openings 42f in a direction along an extending direction of the holding grooves 42d and 42e by coming into contact with the pivot shafts 71D and 71E. On the other hand, the shaft regulating sections 249 allow movement of the pivot shafts 71D and 71E in a moving direction from the openings 42f of the holding grooves 42d and 42e with the moving direction bent, for example, 90 degrees. Consequently, although the pivot shafts 71D and 71E cannot be inserted into and disengaged from the holding grooves 42d and 42e simply by linearly moving the pivot shafts 71D and 71E, the pivot shafts 71D and 71E can be inserted and disengaged if the moving direction is bent.

In this embodiment having the configuration explained above, the grip section 245 of the roll paper holder 204 includes the shaft regulating sections 249. Therefore, according to this embodiment, disengagement of the pivot shafts 71D and 71E from the holding grooves 42d and 42e can be regulated by the shaft regulating sections 249.

The present disclosure is not limited to the embodiments explained above. The concept of the present disclosure can be applied to, for example, a receipt printer or a journal printer provided in a commodity sales registration processing apparatus such as a POS terminal or an electronic cash register as well. The journal printer prints various data corresponding to commodity sales registration processing on belt-like thermal recording paper using predetermined characters. The roll paper holders according to the embodiments can be applied to the journal printer as well.

As explained above, according to the embodiments, it is possible to simplify roll paper replacement work by the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing medium holder comprising:
a housing and holding section detachably attachable to a member holding section of a printing apparatus and configured to house and hold a printing medium wound in a roll shape, the printing medium being wound by rotation of a winding shaft member; and
a winding-shaft holding section provided in the housing and holding section and configured to detachably hold the winding shaft member.

2. The printing medium holder according to claim 1, wherein the winding-shaft holding section includes a holding groove configured to detachably hold a pivot shaft of the winding shaft member.

3. The printing medium holder according to claim 1, further comprising an engaging section configured to join or couple the printing medium holder to another printing medium holder.

4. The printing medium holder according to claim 3, wherein the engaging section includes a projected portion and a recessed portion that respectively fit in a recessed portion and a projected portion provided in the other printing medium holder.

5. The printing medium holder according to claim 2, wherein the winding-shaft holding section includes a shaft regulating section configured to regulate disengagement of the pivot shaft from the holding groove.

6. The printing medium holder according to claim 1, wherein
the winding shaft member includes a fixing section configured to fix a free end side of the printing medium released from a roll state of the printing medium housed and held in the housing and holding section, and
the winding shaft member is detachably attached to the member holding section and winds the printing medium in the roll shape by being driven to rotate.

7. The printing medium holder according to claim 1, further comprising a grip section joined to the housing and holding section.

8. The printing medium holder according to claim 7, wherein
the grip section includes a grip body section to be gripped, and
the grip section is coupled to the housing and holding section to be pivotable between a first position where the grip body section is located above the housing and holding section and the grip section can suspend and support the housing and holding section and a second position where the housing and holding section is located lower compared with a position of the housing and holding section located when the grip section is located in the first position.

9. The printing medium holder according to claim 8, further comprising a pivoting regulating section provided in the housing and holding section and configured to regulate pivoting of the grip section by coming into contact with the grip section that is located in the first position and suspends and supports the housing and holding section.

10. The printing medium holder according to claim 7, wherein the winding-shaft holding section is provided in the grip section.

11. The printing medium holder according to claim 8, wherein
the winding-shaft holding section is provided in the grip section, and
in a state in which the winding shaft member is held by the winding-shaft holding section, an outer circumference of the printing medium wound by winding shaft member can come into contact with an outer circumference of the printing medium housed and held in the housing and holding section.

12. A printing apparatus comprising:
a member holding section;
a printing medium holder including a housing and holding section configured to house and hold a printing medium wound in a roll shape and a winding-shaft holding section provided in the housing and holding section, the printing medium holder being detachably attached to the member holding section; and
a winding shaft member detachably attached to the member holding section and configured to wind the printing medium by being driven to rotate, wherein
the winding-shaft holding section detachably hold the winding shaft member detached from the member holding section.
